(19) United States
(12) Patent Application Publication
(10) Pub. No.: US 2006/0154085 A1
(43) Pub. Date: Jul. 13, 2006

(54) Multilayered article having decorative frit layer for vehicle windshield and method for making same

(75) Inventor: Thomas M. Cleary, Belleville, MI (US)

Correspondence Address: AUTOMOTIVE COMPONENTS HOLDINGS, LLC;c/o MACMILLAN SOBANSKI & TODD, One Maritime Plaza, Fourth Floor, 720 Water Street, Toledo, OH, 43604-1853, US

(73) Assignee: Visteon Global Technologies, Inc.

(21) Appl. No.: 11/034,415

(22) Filed: Jan. 12, 2005

(51) Int. Cl. B32B 17/06

(52) U.S. Cl. 428/426; 428/428; 428/435; 428/437

(57) ABSTRACT

A multilayered article for a windshield of a vehicle and a method of manufacturing the article is provided. The multilayered article comprises an exterior layer having first and second surfaces, and an interior layer having third and fourth surfaces. The interior layer is in side by side relationship with the exterior layer. The article further includes a vinyl layer disposed on the second surface of the exterior layer for bonding the interior layer with the exterior layer. The article further comprises a decorative frit layer applied on the third surface and is configured to cover the periphery of the third surface.

### BACKGROUND OF THE INVENTION

The present invention relates to multilayered articles for vehicle windshields and methods for manufacturing multilayered articles.

Multilayered articles for vehicle windshields are commonly used in the automotive industry. For many years, multilayered articles comprising decorative frit layers have been used, for example, to depict logos and aesthetic works on certain portions of windshields.

Multilayered articles that include decorative frit layers have been applied to automotive glazing such as windshields, body glass, backlites, moon roofs, or sunroofs for a variety of purposes. In one example, a ceramic frit coating is used to block partially or entirely the passage of light through the automotive glazing or can impart a color to the glass pane for decorative, aesthetic or functional purposes. In another example, the ceramic frit coating may be conductive for it to be used in conjunction with a defroster or window-heating unit.

Ceramic frit layers are also used in vehicles to protect the adhesive that bonds the glass to the vehicle from the ultraviolet rays of the sun, to hide electrical wires and other hardware behind the glass, and also to provide a filter for the amount of sunlight allowed into the vehicle such as “half tones” on the moon roof and certain backlites. Further purposes include using the ceramic frit layers to obscure a body opening, to block ultraviolet or infrared rays, as well as providing graphic patterns to the vehicle.

Although current systems are adequate, many improvements may be made on existing multilayered articles for vehicle windshields. For instance, during its use, a windshield may experience several debris impacts, causing cracks and chips on various components thereof. During impact, an elastic pulse causes compressive and tension stresses on surfaces of the article, making these surfaces vulnerable to breakage. Currently, it is known that a ceramic frit layer applied onto a windshield may experience tension stress and weakening first. As the ceramic frit layer experiences tension stress, cracking of the ceramic frit layer may propagate other component surfaces (e.g. glass) to undesirably begin to crack or break across the windshield. Moreover, the ability of the ceramic frit layer to block ultraviolet and infrared rays undesirably diminishes. As a result, the cracks across other surfaces are aesthetically displeasing and the adhesive that bonds the windshield to the vehicle frame begins to undesireably lose its adhesive effectiveness.

Moreover, current articles for windshield are vulnerable to acid rain that leak around the periphery of the windshield. This is undesirable since acid rain may contact and degrade the adhesive layer or the decorative frit layer.

Thus, there is a need to improve multilayered articles for vehicle windshields thereon to reduce the likelihood of breakage during use after a debris impact and to reduce the degradation of the adhesive layer.

### BRIEF SUMMARY OF THE INVENTION

The present invention generally provides an improved multilayered article for a windshield for a vehicle. Embodiments of the present invention provide improved resistance to debris impact during use and thus provide a less likelihood of breakage of the components of the multilayered article.

In one embodiment, the present invention provides a multilayered article for a windshield of a vehicle. The multilayered article comprises an exterior layer having first and second surfaces, and an interior layer having third and fourth surfaces. The interior layer is in side by side relationship with the exterior layer. The article further comprises a polymeric layer disposed between the interior and exterior layers for bonding the interior layer with the exterior layer. The article further comprises a decorative frit layer applied on the third surface and as configured to cover the periphery of the third surface.

In another embodiment, the multilayered article further comprises an adhesive layer disposed on the periphery of the fourth surface to adhere the windshield to the vehicle. In this embodiment, the decorative frit layer is configured to overlap or cover the adhesive layer relative to the exterior layer for protection from ultraviolet rays.

In another example, the present invention provides a method of manufacturing a multilayered article for a windshield of a vehicle. The method comprises providing the interior and exterior layers and screen printing a decorative frit layer on the periphery of the third surface. The method further comprises fusing the decorative frit layer to the third surface and applying a vinyl layer on the second surface of the exterior layer for adhering the interior and exterior layers together. The method further comprises pressing or laminating the interior and exterior layers together.

Further objects, features, and advantages of the present invention will become apparent from consideration of the following description and the appended claims when taken in connection with the accompanying drawings.

### BRIEF DESCRIPTION OF THE DRAWINGS

FIG. 1 is an environmental view of a vehicle having a windshield incorporating a multilayered article in accordance with one embodiment of the present invention;

FIG. 2 is an elevated view of the multilayered article comprising a decorative frit layer in accordance with one embodiment of the present invention;

FIG. 3 is a cross-sectional view of the multilayered article in FIG. 2 taken along line 3-3;

FIG. 4 is a cross-sectional view of the multilayered article in FIG. 3 and depicts a debris impact resulting in an elastic pulse resulting in flexes and compressions on the surfaces of the multilayered article;

FIG. 5a is a cross-sectional view of the multilayered article in accordance with another embodiment of the present invention;

FIG. 5b is a cross-sectional view of the multilayered article in accordance with yet another embodiment of the present invention;

FIG. 5c is a cross-sectional view of the multilayered article in accordance with still another embodiment of the present invention; and

FIG. 6 is a flow chart depicting one method of manufacturing a multilayered article for a windshield of a vehicle in accordance with one example of the present invention.

### DETAILED DESCRIPTION OF THE INVENTION

The present invention generally provides a multilayered article for a windshield of a vehicle and a method for making the multilayered article. The multilayered article includes a decorative or ceramic frit layer disposed on the (Number 3) or third surface of the multilayered article, thereby improving its resistance to debris impacts during vehicle use. By placing the ceramic frit layer on the third surface of the multilayered article, the ceramic frit layer will tend to experience compressive stress rather than tension stress during an elastic pulse caused by debris impact during use. As a result, the likelihood of cracking and breaking of the ceramic frit layer is reduced, thereby increasing the useful life of the windshield.

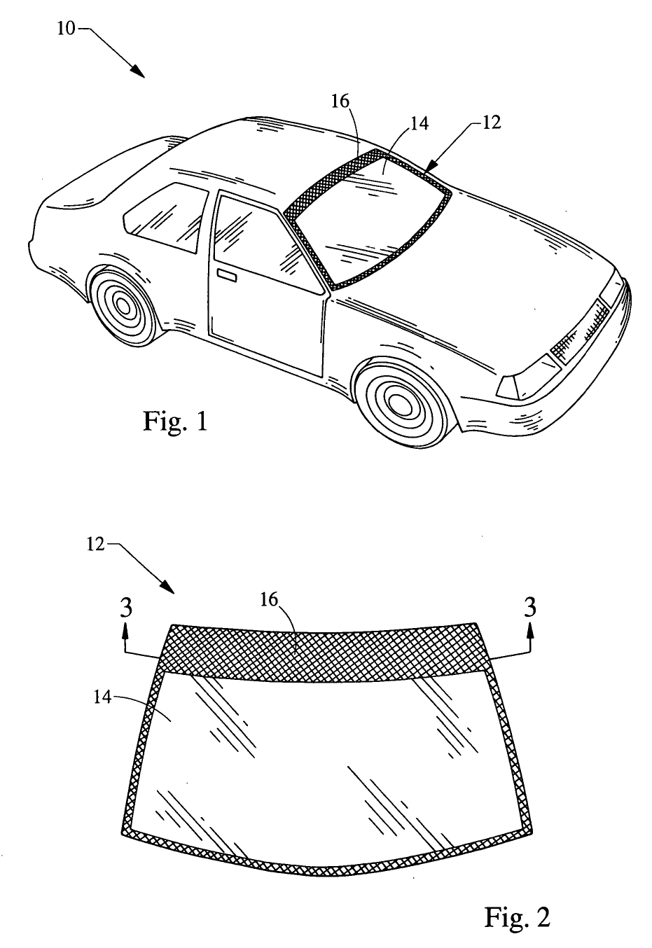

FIG. 1 illustrates a vehicle 10 having a windshield 12 comprised of a multilayered article 14 in accordance with one embodiment of the present invention. As shown in FIGS. 1 and 2, the windshield 12 preferably is a multilayered article having a decorative frit layer 16 disposed along the periphery of the windshield 12 for improved durability. As described in greater detail below, the decorative frit layer 16 is disposed within the multilayered article 14 to protect an adhesive layer of the article from ultraviolet rays for improved durability.

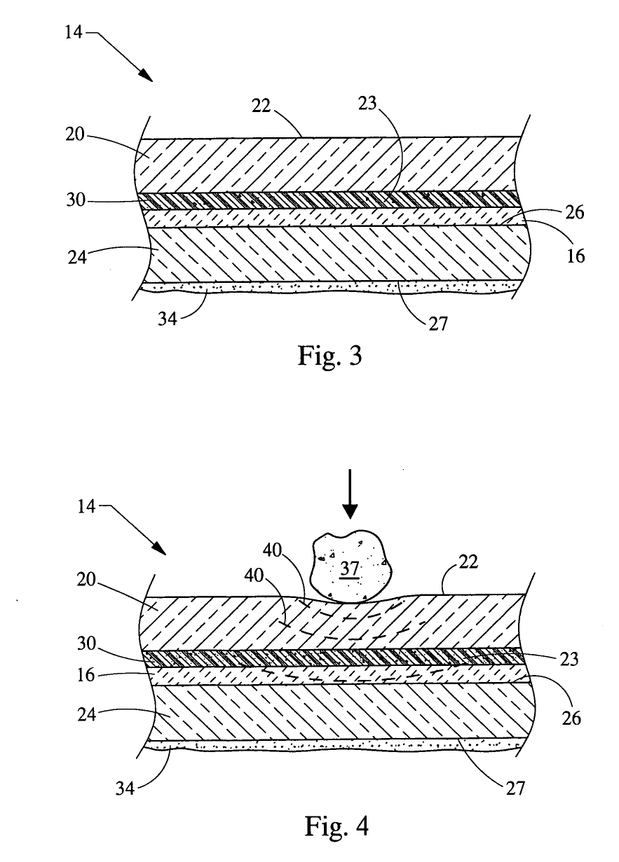

FIG. 3 illustrates a cross-sectional view of the multilayered article 14 depicted in FIG. 2. In this embodiment, the multilayered article 14 comprises an exterior layer 20 having a (number 1) first surface 22 and a (number 2) second surface 23. The exterior layer may be made of any suitable material such as glass. The windshield 12 further includes an interior layer 24 having a (number 3) third surface 26 and a (number 4) fourth surface 27. As shown, the interior layer 24 is in side by side relationship with the exterior layer 20. The interior layer may be made of any suitable material such as glass.

In this embodiment, the multilayered article 14 further includes a vinyl or polymeric layer 30 disposed on the second surface 23 of the exterior layer 20. In this embodiment, the vinyl or polymeric layer 30 includes polyvinyl butyral (PVB). In this embodiment, the purpose for the vinyl layer is to facilitate bonding of the interior layer 24 with the exterior layer 20.

The windshield further includes an adhesive layer 34 disposed on the fourth surface 27 of the interior layer 24 along its periphery to adhere the multilayered article 14 to the vehicle 10. In this embodiment, the adhesive layer 34 is a urethane adhesive layer but may be any other suitable adhesive layer.

As shown, the multilayered article 14 further comprises the decorative frit layer 16 that is applied on the third surface 26 of interior layer 24. In this embodiment, the decorative frit layer 16 is a ceramic frit layer having ceramic frits to preferably reflect or absorb ultraviolet and infrared rays. As shown, the ceramic frit layer 16 is applied along the periphery of the third surface 26 of interior layer 24. However, it is understood that the ceramic frit layer may be applied to other portions of the third surface without falling beyond the scope or spirit of the present invention.

In this embodiment, the decorative frit layer 16 is configured to overlap or cover the adhesive layer 34 relative to the exterior layer 20. The decorative frit layer 16 serves to protect the adhesive layer 34 from ultraviolet rays which degrade the adhesiveness or bonding components of the adhesive layer 34, essentially shortening the life use thereof. However, as mentioned above, the useful life of the adhesive layer may be restricted by the decorative frit layer, since the decorative frit layer weakens or experience breakage more easily than the other layers. Additionally, the decorative frit layer 16 is used for maintaining aesthetics of the windshield.

It has been found that, by disposing the decorative frit layer 16 on the third surface rather than the second surface 23 or fourth surface 27, the decorative frit layer 16 is less likely to experience breakage and allow ultraviolet or infrared rays to pass therethrough to the adhesive layer. Although not wanting to be limited to theory, it is believed that on the third surface the decorative frit layer advantageously experiences compressive stresses rather than undesirably experiencing tension stresses when debris impacts the exterior layer 20 of the multilayered article 14. By placing the decorative frit layer 16 on the third surface, the decorative layer experiences compressive stress during a debris impact, thereby lessening the risk of breakage.

FIG. 4 depicts an effect of debris 37 impacting the windshield 12. As shown, the impact from the debris 37 results in elastic pulses 40 causing flexing and compressing throughout the layers of the multilayered article 14. For example, the second surface 23 and the fourth surface 27 experience tensile stress during impact. On the other hand, the decorative frit layer 16 on the third surface 26 experiences beneficial compressive stress, thereby lessening the risk of breakage.

As mentioned, each of the interior layer 24 and the exterior layer 20 may be made of glass. However, other transparent materials suitable for use in an automotive windshield may also be used. Commercially available PVB material for automotive windshield can be obtained from various vendors. Additionally, a printed vinyl layer having a predefined decorative pattern embedded in the PVB material may also be used.

The decorative frit layer 16 is preferably formed of a predetermined pattern of ceramic paint containing substantially light blocking or reflecting frits. To provide a reflective background for a decorative pattern, the color of the light reflecting frits may be white or other lighter colors such as beige or tan. To provide an absoring background, the color of the light absorbing frits may be black or other darker colors.

Moreover, the decorative frit layer is applied in a dot pattern to provide partial transparency through the multilayered article. In one example, the decorative frit layer is applied on a decorative area in a dot pattern. In one embodiment, the dot pattern may occupy about 40% of the decorative area on which the decorative frit layer is applied. Thus, about 60% of the decorative area is light transparent or open area. Preferably, the decorative area on which the decorative frit layer is applied is occupied by greater than about 15% of the dot pattern, resulting in up to about 85% light transparent or open area through the decorative frit layer.

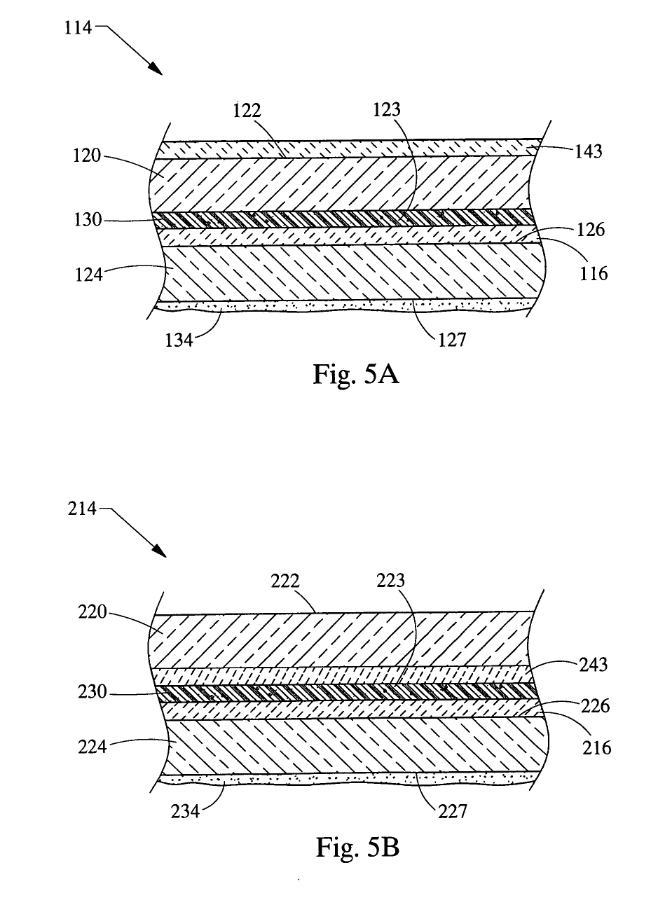

FIGS. 5a-5c illustrate additional embodiments of the present invention. The embodiments shown in FIGS. 5a-5c include components similar to the components described above. For example, decorative frit layer 16; the exterior layer 20; the interior layer 24; the vinyl layer 30; and the urethane layer 34 are similar to the decorative frit layers 116, 216, 316; the exterior layers 120, 220, 330; the interior layers 124, 224, 324; the vinyl layers 130, 230, 330; and the urethane layers 134, 234, 334, respectively.

However, each of FIGS. 5a-5c depicts a second frit layer disposed on additional surfaces of the interior or exterior layers. For example, FIG. 5a illustrates a second frit layer 143 disposed on the first surface 122, FIG. 5b illustrates a second frit layer 243 disposed on the second surface 223, and FIG. 5c illustrates a second frit layer 343 disposed on the fourth surface 327. Preferably, the second frit layers 143, 243, 343 are made of the same material as the decorative frit layer 16 described above.

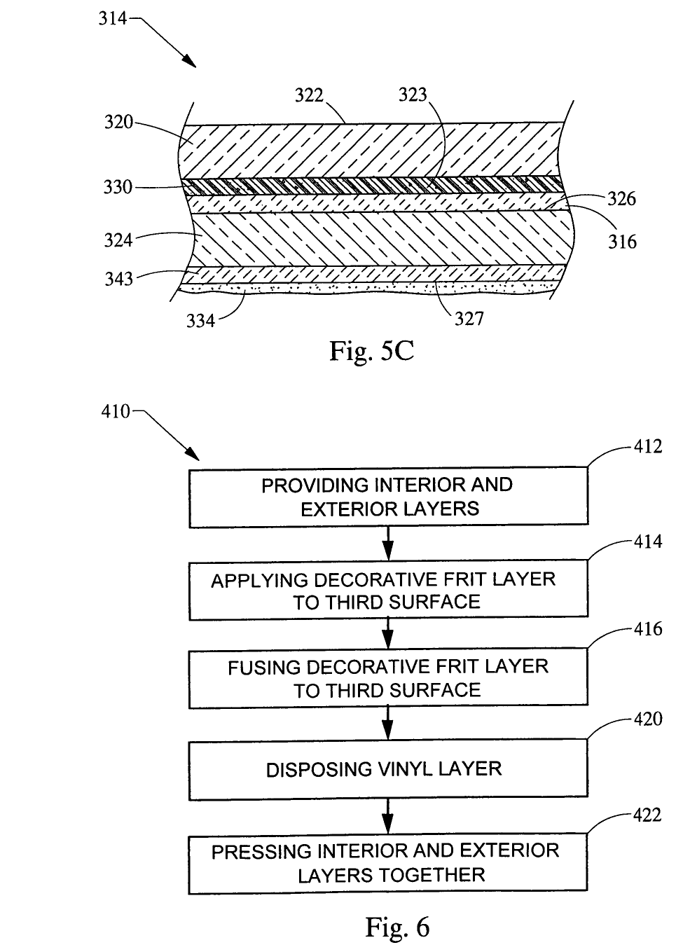

FIG. 6 illustrates a flow chart of one method 410 of manufacturing a multilayered article for a windshield of a vehicle. As shown, the method comprises providing interior and exterior layers of glass in box 412. Preferably, glass portions are cut into two desirable sizes to define interior and exterior portions for the interior and exterior layers, respectively. Preferably, the interior and exterior portions are made of glass and are capable of being formed into predetermined shapes of windshields at an elevated temperature.

In this embodiment, the exterior portion has first and second surfaces and the interior portion has third and fourth surfaces. When completed, the first and second surfaces of the exterior portion will be the first and second surfaces of the exterior layer. When completed, the third and fourth surfaces of the interior portion will be the third and fourth surfaces of the interior layer.

The method further comprises applying a decorative frit layer on a peripheral area of the third surface in box 414. Preferably, the decorative frit layer is screen printed on the third surface of the interior layer. In this embodiment, the decorative frit layer is formed of a ceramic paint containing metal oxides and ceramic frits suspended in a known solvent. The ceramic frits are in a finely ground form of glass binder also known as “flux.”

In box 416, the interior and exterior layers are heated to the elevated temperature to soften the glass and to fuse the ceramic paint to the third surface of the interior layer. This may be accomplished by setting the interior and exterior layers on metal baskets in contact at the periphery of each layer in a furnace. The furnace is then heated to the elevated temperature. In one embodiment, the elevated temperature is about 1150 degrees Fahrenheit (° F.). At the elevated temperature, the ceramic frit melts and binds the metal oxides, while fusing to the third surface of the interior layer in box 116 on which it is applied. During heating, the layers drop or sag due to gravity to a desirable shape and contour of the windshield of the vehicle.

In this embodiment, the metal oxides may provide the color of the ceramic frit. In one embodiment, most of the oxides will be dissolved by the melting frit at the elevated temperature. In this embodiment, the organic solvent is a temporary part of the ceramic paint. The heat in the step of fusing in box 416 causes the organic solvent to evaporate or burn off and leave the frit and oxides in the form seen on the third surface of the interior layer. The interior and exterior layers then are allowed to cool to room temperature.

Alternatively, the multilayered article may be formed by a pressbend process. In one example, the interior and exterior layers may be heated separately from each other, and separately placed in a male mold to form a desirable shape and contour. Each of the layers may then be cooled to room temperature. In a second example, the interior and exterior layers may be pressed simultaneously.

In this example, the vinyl layer is then disposed between the exterior and interior layers in box 420 for adhering the interior layer to the exterior layer. As mentioned above, the vinyl layer preferably includes PVB. The interior and exterior layers are then aligned with each other and pressed or laminated together in box 422. Preferably, the interior and exterior layers are brought into an autoclaving process for high pressure treatment. For example, the autoclaving temperature may be at about 300° F. and the pressure may be at about 250 pounds per square inch (psi). The vinyl layer serves to bond the interior and exterior layers together.

After cooling, the adhesive layer is applied to the fourth surface along the peripheral area of the windshield. The adhesive layer is configured to be applied onto the fourth surface such that the decorative frit layer covers and protects the adhesive layer from ultraviolet and infrared rays from the exterior of the vehicle. As a result, the life use of the adhesive layer is maximized, minimizing on adhesive degradation thereof.

While the present invention has been described in terms of preferred embodiments, it will be understood, of course, that the invention is not limited thereto since modifications may be made to those skilled in the art, particularly in light of the foregoing teachings.

1. A multilayered article for a windshield of a vehicle, the article comprising:
an exterior layer having first and second surfaces;
an interior layer having third and fourth surfaces, the interior layer being in side by side relationship with the exterior layer so that the third surface faces the second surface;
a polymeric layer disposed on the second surface of the exterior layer for bonding the interior layer with the exterior layer; and
a decorative frit layer applied on the third surface.

2. The article of claim 1 further comprising an adhesive layer disposed along the periphery of the fourth surface to adhere the windshield to the vehicle, the decorative frit layer being configured to overlap the adhesive layer for protection from ultraviolet rays.

3. The article of claim 1 wherein the interior and exterior layers are glass layers.

4. The article of claim 2 wherein the adhesive layer is a urethane adhesive layer.

5. The article of claim 1 wherein the polymeric layer includes polyvinyl butyral.

6-11. (canceled)

12. A multilayered article for a windshield of a vehicle, the article comprising:
an exterior layer having first and second surfaces;
an interior layer having third and fourth surfaces, the interior layer being in side by side relationship with the exterior layer;
a vinyl layer disposed on the second surface of the exterior layer for bonding the interior layer with the exterior layer;
an adhesive layer disposed on the periphery of the fourth surface to adhere the windshield to the vehicle; and
a decorative frit layer applied along the periphery of the third surface, the decorative frit layer being configured to overlap the adhesive layer for protection from ultraviolet rays.

13. The multilayered article of claim 12 wherein the interior and exterior layers are made of glass.

14. The article of claim 12 wherein the adhesive layer is a polyurethane adhesive layer.

15. The article of claim 12 wherein the vinyl layer includes polyvinyl butyral.

16. The article of claim 12 further comprising a second frit layer disposed on the first surface.

17. The article of claim 12 further comprising a second frit layer disposed on the second surface.

18. The article of claim 12 further comprising a second frit layer disposed on the fourth surface.
